(19) United States
(12) Patent Application Publication
(10) Pub. No.: US 2005/0216759 A1
(43) Pub. Date: Sep. 29, 2005

(54) Virus scanning of input/output traffic of a computer system

(76) Inventors: Michael A. Rothman, Puyallup, WA (US); Vincent J. Zimmer, Federal Way, WA (US)

Correspondence Address: Anthony H. Azure;BLAKELY, SOKOLOFF, TAYLOR & ZAFMAN LLP, Seventh Floor, 12400 Wilshire Boulevard, Los Angeles, CA, 90025, US

(21) Appl. No.: 10/811,719

(22) Filed: Mar. 29, 2004

(51) Int. Cl. H04L 9/00

(52) U.S. Cl. 713/200

(57) ABSTRACT

A method, system and article of manufacture to virus scan input/output (I/O) traffic of a computer system. A virus scanner is initialized during a pre-boot phase of a computer system. Data read from an input/output (I/O) device of the computer system is scrubbed by the virus scanner using a virus signature database before the data is loaded. A platform policy is enacted if a virus is detected in the data.

### BACKGROUND

1. Field of Invention

The field of invention relates generally to computer systems and, more specifically but not exclusively, relates to virus scanning of input/output traffic of a computer system.

2. Background Information

Today's computer systems are under constant attack from computer viruses. Viruses often disrupt a system's operations and can destroy stored data. With the increased use of the Internet, viruses can spread quickly to systems on a worldwide scale. In order to prevent the infection of computer systems, users employ anti-virus software.

Usually, systems launch an operating system before any anti-virus software is executed. Such anti-virus software is dependent upon the state of the operating system. Also, changes or updates to the operating system often require a change to the anti-virus software. This can be expensive and burdensome in a corporate network deploying various operating systems across multiple platforms. Since the anti-virus software works in the OS domain, the anti-virus software itself is vulnerable to attack from viruses.

Current anti-virus software may be defeated by virus attacks initiated during the pre-boot phase. These viruses are referred to as boot sector viruses. Such viruses may modify the anti-virus software's registry settings, disable the anti-virus software, or perform other modifications to the anti-virus software to make the computer system susceptible to infection.

Also, modern virus scanning techniques require the anti-virus software to have knowledge of the file system under which information is stored. To effectively scan stored files, the anti-virus software searches through files types based on name extensions, such as .exe, .dat, .bin, etc. Being tied to certain file systems limits the flexibility of these anti-virus programs.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of virus scanning input/output traffic of a computer system in accordance with the teachings of the present invention.

FIG. 2 is a block diagram illustrating one embodiment of virus scanning input/output traffic of a computer system in accordance with the teachings of the present invention.

FIG. 3 is a flowchart illustrating one embodiment of the logic and operations to virus scan input/output traffic of a computer system in accordance with the teachings of the present invention.

FIG. 4 is a block diagram illustrating one embodiment of updating a virus signature database in accordance with the teachings of the present invention.

FIG. 5 is a flowchart illustrating one embodiment of the logic and operations to virus scan input/output traffic of a computer system in accordance with the teachings of the present invention.

FIG. 6 is a block diagram illustrating one embodiment of an exemplary computer system to implement embodiments of the present invention.

### DETAILED DESCRIPTION

Embodiments to provide virus scanning of input/output traffic of a computer system are described herein. In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the present invention may employ a firmware environment known as the Extensible Firmware Interface (EFI) (Extensible Firmware Interface Specification, Version 1.10, Dec. 1, 2002, available at http://developer.intel.com/technology/efi.) EFI is a public industry specification that describes an abstract programmatic interface between platform firmware and operating systems or other application environments. EFI enables firmware, in the form of firmware modules and drivers, to be loaded from a variety of different resources, including non-volatile storage devices, such as flash memory, option ROMs (Read-Only Memory), storage devices (e.g., hard disks, CD-ROM (Compact Disk-Read Only Memory), etc.), or from one or more computer systems over a computer network.

The pre-boot phase of a computer system is generally defined as the firmware that runs between the processor reset and the first instruction of an Operating System (OS) loader. At the start of a pre-boot, it is up to the code in the firmware to initialize the system to the point that an operating system loaded off of media, such as a hard disk, can take over. The start of the OS load begins the period commonly referred to as OS runtime. During OS runtime, the firmware may act as an interface between software and hardware components of a computer system and provide other support to the computer system. The operational environment between the OS level and the hardware level is generally referred to as the firmware or the firmware environment.

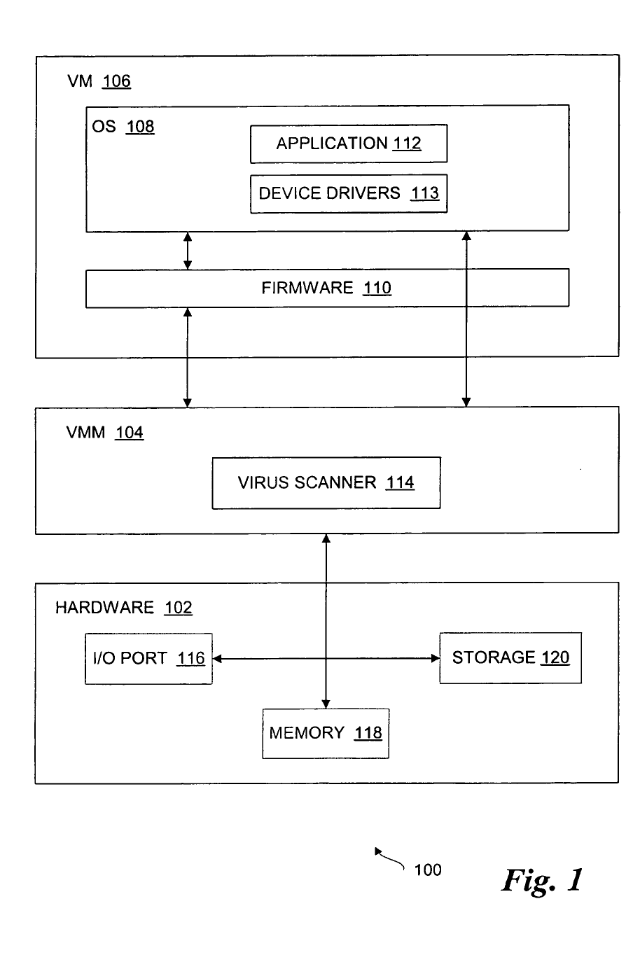

Referring to FIG. 1, one embodiment of a computer system 100 is shown. Computer system 100 includes a Virtual Machine (VM) 106 layered on top of a Virtual Machine Monitor (VMM) 104. The VMM is layered on top of the platform hardware 102. While FIG. 1 shows one VM 106, computer system 100 may include multiple VMs layered on VMM 104. In one embodiment, computer system 100 employs the Intel Vanderpool Technology (VT).

A VM behaves like a complete physical machine that can run its own OS. Usually, each VM session is given the illusion by the VMM that it is the only physical machine. The VMM takes control whenever a VM attempts to perform an operation that may affect the whole computer system 100. Each VM supports a corresponding OS and firmware. Multiple VM sessions are separate entities and usually isolated from each other by the VMM. If one OS crashes or otherwise becomes unstable, the other OS's should not be adversely affected.

VM 106 includes an operating system (OS) 108 and firmware 110. OS 108 includes application 112 and devices drivers 113. Firmware 110 emulates the firmware of the computer system 100 to support VM 106.

VMM 104 includes a virus scanner 114. In one embodiment, virus scanner 114 is loaded from non-volatile storage, such as a flash memory device. Virus scanner 114 operates from the firmware environment of the computer system 100 and is independent of an operating system. In one embodiment, VMM 104 and virus scanner 114 operate in compliance with the EFI specification.

Platform hardware 103 includes an Input/Output (I/O) port 116, memory 118, and a storage device 120. I/O port 116 and storage device 120 are considered Input/Output (I/O) devices of computer system 100 that generate I/O traffic when transferring data in computer system 100. I/O port 116 includes a network interface card (NIC), a Universal Serial Bus (USB) port, a parallel port, a Small Computer System Interface (SCSI) port, or the like. Storage device 120 includes a magnetic storage device, an optical storage device, a non-violate storage device, such as flash memory, or the like.

Virus scanner 114 monitors input/output (I/O) traffic from I/O port 116 and storage 120. In one embodiment, VMM 104 acts as an I/O controller whenever application 112 or OS 108 requests data from I/O port 116 or storage 120. In this instance, when the data is retrieved, virus scanner 114 scrubs the data for viruses before the data is loaded into memory 118.

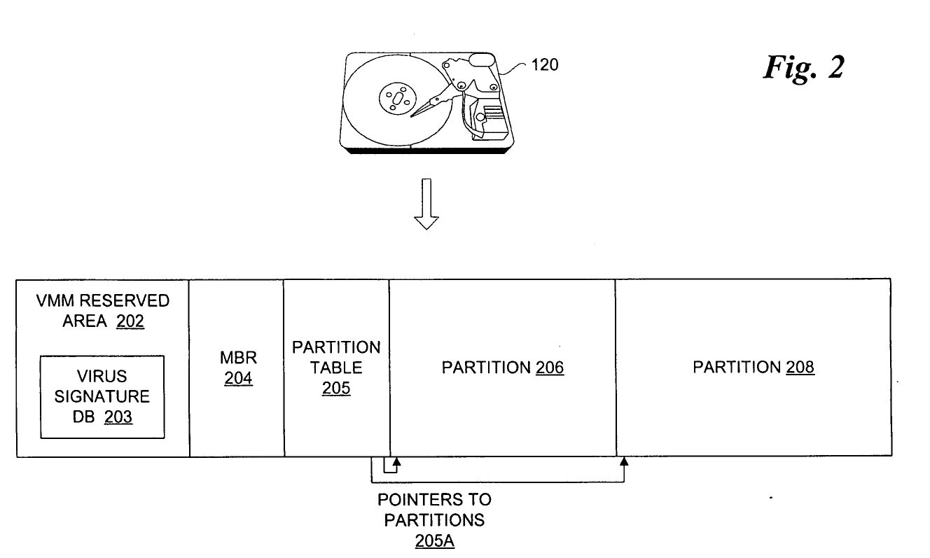

FIG. 2 illustrates one embodiment of storage 120 to store a virus signature database 203 for use by virus scanner 114. In the embodiment of FIG. 2, storage 120 is a hard disk drive. Storage 120 includes a VMM reserved area 202, a Master Boot Record (MBR) 204, a partition table 205, a partition 206, and a partition 208. Partitions 206 and 208 are logical divisions of storage 120.

Generally, a virus signature database is maintained in a place not exposed to an operating system of the computer system 100. In one embodiment, the virus signature database is stored in a firmware-reserved area of storage 120, such as a VMM reserved area, a Host Protected Area (HPA), or the like. In FIG. 2, the VMM reserved area 202 stores the virus signature database 203. The virus signature database 203 includes virus signatures used by the virus scanner to facilitate the identification of viruses.

Partition table 205 includes pointers 205A that indicate the beginning of partitions 206 and 208. Partition table 205 may also indicate the number of partitions and the size of each partition. Each partition 206 and 208 may include an operating system. Partition table 205 may also indicate the active partition whose OS is to be loaded at OS runtime. FIG. 2 illustrates two partitions 206 and 208, however, it will be understood that storage device 120 may include more or less partitions.

MBR 204 is used to boot an OS on computer system 100. In one embodiment, the MBR 204 is loaded into memory and executed. MBR 205 locates the active partition using partition table 205. The boot record of the active partition is loaded into memory and executed. The boot record contains the OS loader that is used to load the OS of the active partition.

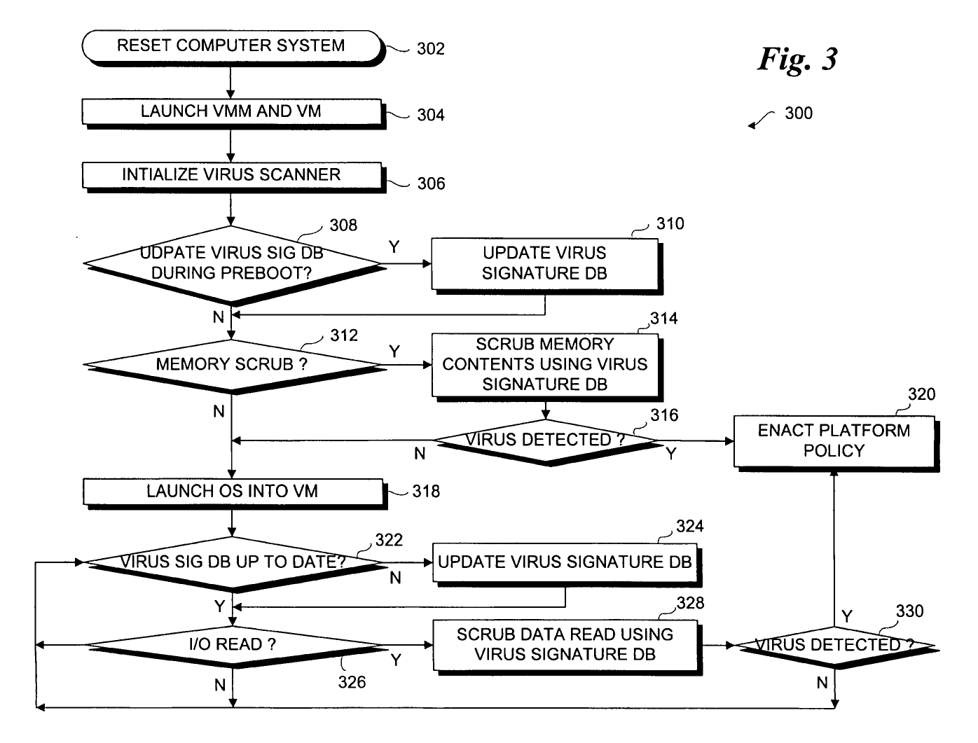

FIG. 3 illustrates a flowchart 300 of one embodiment to provide virus scanning of input/output traffic of a computer system. Starting in a block 302, the computer system is reset. Boot instructions stored in the computer system firmware are loaded and executed. In one embodiment, the system boot instructions will begin initializing the platform by conducting a Power-On Self-Test (POST) routine.

Continuing to a block 304, the VMM 104 and the VM 106 are launched. In a block 306, the virus scanner is initialized. Proceeding to a decision block 308, the logic determines if the virus signature database is to be updated during the pre-boot phase of the computer system.

If the answer to decision block 308 is yes, then the logic continues to a block 310 to update the virus signature database with updated virus signatures. In one embodiment, the updated virus signatures may be stored on an optical disk that is placed in an optical disk drive of computer system 100. In another embodiment, the updated virus signatures are downloaded to the computer system 100 from another computer system communicatively coupled to computer system 100. In yet another embodiment, VMM 104 is substantially compliant with the EFI specification such that VMM 104 may abstract network interface 116 to download updated virus signatures. After updating the virus signature database, the logic continues to a decision block 312, discussed below.

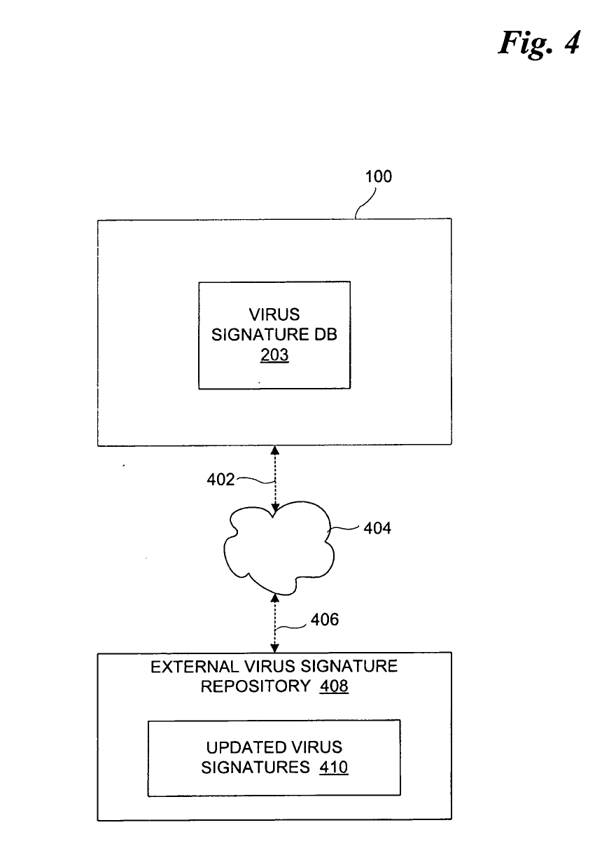

Referring to FIG. 4, one embodiment of updating the virus signature database is shown. Computer system 100 includes virus signature database 203. Computer system 100 is coupled to a network 404 via connection 402. An external virus signature repository 408 is coupled to the network 404 via connection 406. Network 404 may include a local area network (LAN), wide area network (WAN), an internet, or the like. Connections 402 and 406 may include wired connections, wireless connections, or a combination of wired and wireless connections.

Repository 408 has stored updated virus signatures 410. Computer system 100 may download updated virus signatures from repository 408. In one embodiment, repository 408 is part of a server to provide downloading of updated virus signatures 410 to computer system 100 via the Internet.

Referring again to FIG. 3, if the answer to decision block 308 is no, then the logic proceeds to a decision block 312. In decision block 312, the logic determines if memory 118 of computer system 100 is to be scrubbed. In one embodiment, the scrubbing of memory during pre-boot is based on a platform policy. In another embodiment, the user may be queried during pre-boot about conducting a memory scrub. If the answer to decision block 312 is yes, then the logic proceeds to a block 314 to scrub the memory contents using the virus signature database 203.

Proceeding to a decision block 316, if a virus is detected in memory 118 during the scrub, then the logic proceeds to a block 320 to enact the platform policy when a virus is detected. In one embodiment, an error signal is generated indicating a virus has been detected. If a virus is not detected in a block 316, then the logic proceeds to a block 318 to launch an OS into the VM.

If the answer to decision block 312 is no, then the logic proceeds to block 318 to launch the OS. Continuing to a decision block 322, the logic determines if the virus signature database is up to date. In one embodiment, the virus scanner 114 queries an external virus signature repository to determine if virus signature database has the latest virus signatures. If the answer to decision block 322 is no, then the logic proceeds to a block 324 to update the virus signature database, and then to a decision block 326. If the answer to decision block 322 is yes, then the logic proceeds to decision block 326.

In decision block 326, the logic determines if an input/output read has been requested. If the answer is no, then logic proceeds back to decision block 322. It will be appreciated that in the embodiment of flowchart 300, the logic repeatedly checks for updates to the virus signature database in block 322. New viruses are discovered on a daily basis, so it is prudent to maintain the most current virus signature database.

If the answer to decision block 326 is yes, then the logic proceeds to a block 328 to scrub the data read using the virus signature database 328. The virus scanner will scrub data that is requested from an I/O device before the data is loaded into memory, a processor register, or the like. I/O devices include storage devices, network interfaces, or the like. Generally, the virus scanner reviews data before it is loaded for execution by the computer system. In this way, the virus scanner may catch a virus before the virus is allowed to act.

Proceeding to a decision block 330, the logic determines if a virus is detected during the scrub of the data. If the answer to decision block 330 is no, then the logic returns to block 322. If the answer to decision block 330 is yes, then the logic proceeds to block 320.

In another embodiment of the invention, the virus scanner performs behavioral checking of input/output activity. Behavioral checking involves identifying behavior that is non-normal even though a virus has not been detected. For example, the virus scanner may notice repeated pings received at a network interface card of the computer system. Such behavior may indicate a denial-of-service attack on the computer system. In another example, the virus scanner may detect an attempt to modify the master boot record. In yet another example, the virus scanner may detect suspicious reads of system files, such as registry information, that indicate a virus is looking for vulnerabilities in the computer system.

It will be appreciated that by scrubbing memory during the pre-boot phase, the virus scanner may discover viruses during pre-boot. A common target of viruses is to position themselves in the master boot record of the computer system in order to be executed at the time of OS load. Viruses that hide in the master boot record may attempt to modify or disable an OS-based anti-virus software before the software has a chance to boot. Embodiments of the present invention scan the contents of memory for viruses during pre-boot. In this way, a virus that has been loaded from the master boot record may be discovered before the virus is executed.

It will also be appreciated that the virus scanner operates independently of an operating system executing on the computer system; the virus scanner is considered OS agnostic. The virus scanner may be employed during pre-boot, OS runtime, and OS after-life. Further, since the virus scanner executes without dependency upon the OS, the virus scanner may be used on a variety of platforms having a variety of operating systems. The update or changing of an OS on a particular system does not necessitate the updating or changing of the virus scanner. Also, since the virus scanner is outside the domain of an OS, the virus scanner is less vulnerable to attack.

It will be appreciated that the virus scanner does not need knowledge of the file system of an I/O device to scrub the data read from the I/O device. The virus scanner does not suffer from the limitation of needing an ability to understand the file system of a storage device in order to scan information on the storage device. In an embodiment using a VMM, since the VMM will emulate an I/O controller, such as a disk controller, the virus scanner may scrub requested data without having knowledge of a file system of the data.

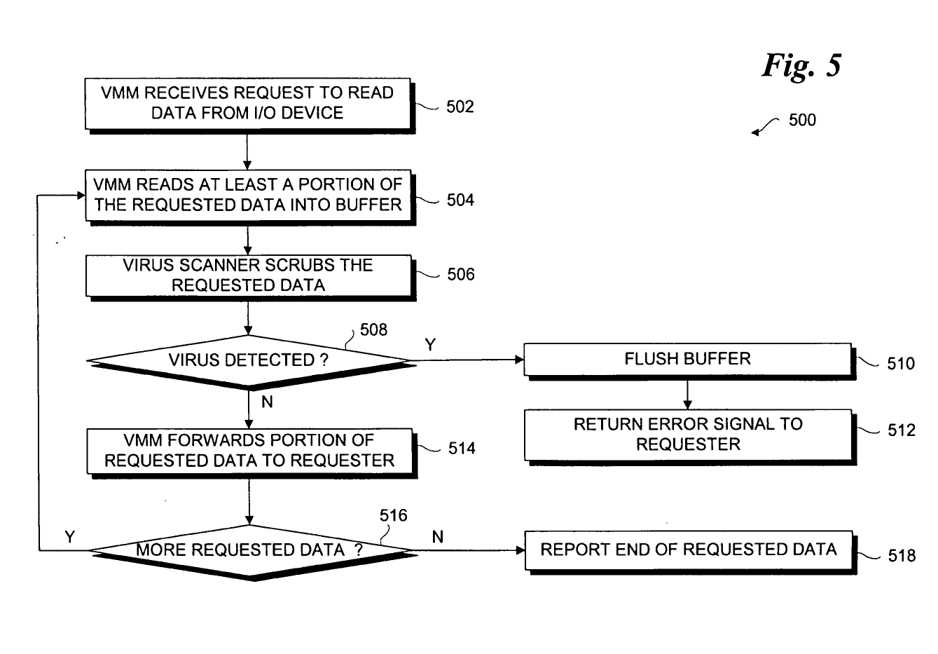

FIG. 5 illustrates a flowchart 500 showing one embodiment of scrubbing data read from an I/O device with virus scanner 114. Starting in a block 502, the VMM 104 receives a request to read data from an I/O device. It will be appreciated that VMM 104 acts as an I/O controller, such as a disk controller, a NIC controller, or the like. Requesters of data include, but are not limited to, an operating system, an application, a virtual machine, or the like.

Continuing to a block 504, at least a portion of the requested data is read into a buffer by the VMM. In one embodiment, the device driver of the I/O device defines the amount of data read by the VMM at one time. Proceeding to a block 506, the virus scanner scrubs the requested data in the buffer for viruses using the virus signature database.

Proceeding to a decision block 508, the logic determines if a virus has been detected during the scrub. If the answer to decision block 508 is yes, then the logic flushes the buffer containing the infected data, as depicted in a block 510, and then proceeds to a block 512 to return an error signal to the requester indicating the requested data is infected with a virus.

If the answer to decision block 508 is no, then the logic proceeds to a block 514 where the VMM forwards the portion of requested data to the requester. In one embodiment, the VMM loads the requested data in a volatile storage accessible by the requester. Such volatile storage includes a memory device, a register, or the like.

The logic then continues to a decision block 516 to determine if there is more requested data to be read from the I/O device. If the answer is yes, then the logic returns to block 504 to read more requested data. If the answer is no, then the logic proceeds to a block 518 to report the end of the requested data to the requester.

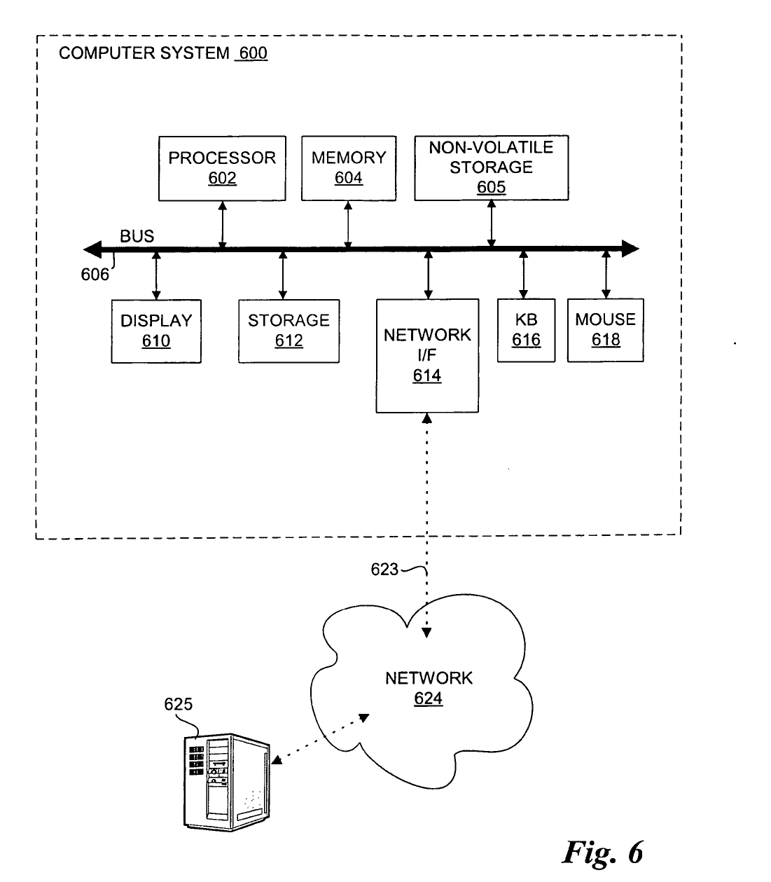

FIG. 6 is an illustration of one embodiment of an example computer system 600 on which embodiments of the present invention may be implemented. Computer system 600 includes a processor 602 coupled to a bus 606. Memory 604, storage 612, non-volatile storage 605, display 610, and network interface 614 are also coupled to bus 606. The computer system 600 may interface to external systems through the network interface 614. Network interface 614 may include, but is not limited to, a modem, a network interface card (NIC), a T-1 line interface, a T-3 line interface, a token ring interface, a satellite transmission interface, or other interfaces for coupling a computer system to other computer systems. A carrier wave signal 623 is received/transmitted by network interface 614. In the embodiment illustrated in FIG. 6, carrier wave signal 623 is used to interface computer system 600 with a network 624, such as a local area network (LAN), a wide area network (WAN), or the Internet. In one embodiment, network 624 is further coupled to a remote computer 625 such that computer system 600 and the remote computer 625 may communicate over network 624.

Processor 602 may include, but is not limited to, an Intel Corporation x86, Pentium®, Xeon™, or Itanium® family processor, a Motorola family processor, or the like. In one embodiment, computer system 600 may include multiple processors.

Memory 604 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Display 610 may include a cathode ray tube (CRT), a liquid crystal display (LCD), an active matrix display, or the like. A keyboard (KB) 616 and a mouse 618 are coupled to bus 606 to allow a user to interact with computer system 600.

The computer system 600 also includes non-volatile storage 605 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), or the like.

Storage 612 includes, but is not limited to, a magnetic hard disk, a magnetic tape, an optical disk, or the like. Some data may be written by a direct memory access process into memory 604 during execution of software in computer system 600. It is appreciated that instructions executable by processor 602 may reside in storage 612, memory 604, non-volatile storage 605 or may be transmitted or received via network interface 614.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., a read only memory (ROM), a random access memory (RAM), a magnetic disk storage media, an optical storage media, a flash memory device, etc.). In addition, a machine-accessible medium can include propagated signals such as electrical, optical, acoustical or other form of propagated signals (e.g., carrier waves, infrared signals, digital signals, etc.).

It will be appreciated that computer system 600 is one example of many possible computer systems that have different architectures. For example, computer systems that utilize the Microsoft Windows® operating system in combination with Intel processors often have multiple buses, one of which may be considered a peripheral bus. Workstation computers may also be considered as computer systems that may be used with embodiments of the present invention. Workstation computers may not include a hard disk or other mass storage, and the executable instructions may be loaded from a corded or wireless network connection into memory 604 for execution by processor 602. In addition, handheld or palmtop computers, which are sometimes referred to as personal digital assistants (PDAs), may also be considered as computer systems that may be used with embodiments of the present invention. A typical computer system will usually include at least a processor 602, memory 604, and a bus 606 coupling memory 604 to processor 602.

It will also be appreciated that in one embodiment, computer system 600 may execute operating system software. For example, one embodiment of the present invention utilizes Microsoft Windows® as the operating system for computer system 600. Other operating systems that may also be used with computer system 600 include, but are not limited to, the Apple Macintosh operating system, the Linux operating system, the Microsoft Windows CE® operating system, the Unix operating system, or the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to embodiments of the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method, comprising:
initializing a virus scanner during a pre-boot phase of a computer system;
scrubbing data read from an input/output (I/O) device of the computer system by the virus scanner using a virus signature database before the data is loaded; and
enacting a platform policy if a virus is detected in the data.

2. The method of claim 1, further comprising scrubbing contents of a memory device of the computer system during the pre-boot phase by the virus scanner.

3. The method of claim 1, further comprising updating the virus signature database with updated virus signatures.

4. The method of claim 3 wherein the virus signature database is updated during the pre-boot phase.

5. The method of claim 1 wherein the virus signature database is not exposed to an operating system executing on the computer system.

6. The method of claim 5 wherein the virus signature database is stored in a firmware-reserved area.

7. The method of claim 1 wherein the virus scanner is executing in a virtual machine monitor (VMM) executing on the computer system, the VMM supporting at least one virtual machine (VM) executing on the computer system.

8. The method of claim 7 wherein scrubbing data read from the I/O device includes:
receiving a request from a requester to read data from the I/O device, the requester in a VM of the at least one VM;
loading at least a portion of the requested data into a buffer;
scrubbing the at least a portion of the requested data with the virus scanner;
returning an error signal to the requester if the virus scanner detects a virus in the at least a portion of the requested data; and
forwarding the requested data to the requester if the virus scanner does not detect a virus in the at least a portion of the requested data.

9. The method of claim 1 wherein the virus scanner is operable during the pre-boot phase, an operating system (OS) runtime phase, and an after-life phase of the computer system independent of an operating system of the computer system.

10. The method of claim 1 wherein the virus scanner scrubs the data without having knowledge of a file system of the data.

11. The method of claim 1, further comprising enacting the platform policy if the virus scanner detects non-normal behavior within the computer system.

12. An article of manufacture comprising:
a machine-accessible medium including a plurality of instructions which when executed perform operations comprising:
initializing a virus scanner during a pre-boot phase of a computer system;
scrubbing contents of a memory device of the computer system during the pre-boot phase by the virus scanner using a virus signature database;
scrubbing data read from an input/output (I/O) device of the computer system by the virus scanner using the virus signature database before the data is loaded; and
generating an error signal if a virus is detected by the virus scanner.

13. The article of manufacture of claim 12, further comprising receiving updated virus signatures at the computer system to update the virus signature database.

14. The article of manufacture of claim 12 wherein the virus signature database is stored in a place not exposed to an operating system of the computer system.

15. The article of manufacture of claim 12 wherein the virus scanner to be operable during the pre-boot phase, an operating system (OS) runtime phase, and an after-life phase of the computer system independent of an operating system of the computer system.

16. The article of manufacture of claim 12 wherein the virus scanner to scrub the data without having knowledge of a file system of the data.

17. The article of manufacture of claim 12 wherein scrubbing data read from the I/O device includes:
launching a virtual machine monitor (VMM), the virus scanner to operate from the VMM; and
launching a virtual machine (VM) to be supported by the VMM.

18. The article of manufacture of claim 17 wherein execution of the plurality of instructions further perform operations comprising:
receiving a request from a requester in the VM to read data from the I/O device;
loading at least a portion of the requested data into a buffer;
scrubbing the at least a portion of the requested data with the virus scanner;
returning an error signal to the requester if the virus scanner detects a virus in the at least a portion of the requested data; and
forwarding the requested data to the requester if the virus scanner does not detect a virus in the at least a portion of the requested data.

19. The article of manufacture of claim 12 wherein the plurality of instructions to operate substantially in compliance an Extensible Firmware Interface (EFI) specification.

20. A computer system, comprising:
a processor;
a memory device operatively coupled to the processor;
a storage device operatively coupled to the processor; and
at least one flash memory device operatively coupled to the processor, the at least one flash memory device including firmware instructions which when executed by the processor perform operations comprising:
initializing a virus scanner during a pre-boot phase of a computer system;
scrubbing contents of the memory device during the pre-boot phase by the virus scanner using a virus signature database;
scrubbing data read from the storage device by the virus scanner using the virus signature database before the data is loaded in the memory device; and
generating an error signal if a virus is detected by the virus scanner.

21. The computer system of claim 20, further comprising a network interface operatively coupled to the processor, the virus scanner to scrub data read from the network interface using the virus signature database before the data is loaded in the memory device.

22. The computer system of claim 20 wherein the virus signature database is stored in a firmware reserved area of the storage device, the firmware reserved area not exposed to an operating system of the computer system.

23. The system of claim 20 wherein execution of the firmware instructions further perform operations comprising updating the virus signature database with updated virus signatures downloaded from an external virus signature repository communicatively coupled to the computer system.

24. The computer system of claim 20 wherein the virus scanner is operable during the pre-boot phase, an operating system (OS) runtime phase, and an after-life phase of the computer system independent of an operating system of the computer system.

25. The computer system of claim 20 wherein the virus scanner to scrub the data without having knowledge of a file system of the storage device.

26. The computer system of claim 20 wherein the firmware instructions to operate substantially in compliance with an Extensible Firmware Interface (EFI) specification.

27. A computer system, comprising:
a virtual machine monitor (VMM) to support at least one virtual machine (VM);
an input/output (I/O) device, the VMM to emulate an I/O controller for the I/O device;
a virus scanner within the VMM to scrub data read from the I/O device before the data is loaded; and
a virus signature database to facilitate identification of a virus by the virus scanner.

28. The computer system of claim 27 wherein the virus scanner is operable during the pre-boot phase, an operating system (OS) runtime phase, and an after-life phase of the computer system independent of an operating system of the computer system.

29. The computer system of claim 27 wherein the virus scanner to scrub the data without having knowledge of a file system of the I/O device.

30. The computer system of claim 27 wherein the VMM and the virus scanner to operate substantially in compliance with an Extensible Firmware Interface (EFI) specification.
